(19) United States
(12) Patent Application Publication
(10) Pub. No.: US 2021/0156166 A1
(43) Pub. Date: May 27, 2021

(54) Memorial Having Persistent Computer-Readable Memory and Interface Means

(71) Applicant: Gregory Raab, Las Vegas, NV (US)

(72) Inventor: Gregory Raab, Las Vegas, NV (US)

(21) Appl. No.: 16/693,280

(22) Filed: Nov. 23, 2019

(51) Int. Cl. E04H 13/00; G06K 19/07; G06F 1/16

(52) U.S. Cl. CPC E04H 13/003; G06F 1/1656; G06K 19/0723

(57) ABSTRACT

An improvised memorial stone for a grave, the memorial stone having computer-readable memory accessible through a port protected from the elements by a cantilevering table stone. In various embodiments, skeletal remains of the deceased further comprise an RFID tag encased in a non-biodegradable polymeric material. The computer-readable memory and RFID tag are adapted to transmit a unique identifier exclusively associated with the deceased and personal data about the deceased, including, by way of example, photographs, life stories, journal entries, and genealogical information.

### BACKGROUND

### Field of the Invention

This invention relates to gravestones and memorials, and more particularly relates to memorials having persistent computer-readable memory and computer interface means.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Gravestones, cenotaphs and other engraved memorials traditionally made of rock such as granite, quartz or sandstone are commonly placed in memory of the dead, typically at the head of a grave in a cemetery or elsewhere to commemorate the life of a deceased individual. Throughout history, the words engraved upon a gravestone have tended, in many cases, to eventually become all the data which survives about the particular deceased individual to whom the memorial pays tribute. Typically, this engraved data comprises simply the name of the deceased person, a date of birth and death, and sometimes the names of spouses and/or children. Gravestones and memorials may also incorporate religious symbology, but typically have little to no data about the life of the individual commemorated.

Individuals, including the deceased's posterity, often visit the gravesites of the deceased to honor their memory and bereave their departure. Because of the difficulty of engraving stone, and the limited area available upon the face of gravestones and memorials, information goes unrecorded on gravestones and is lost about the departed over time. A gravestone or memorial quite often becomes the only tangible remnant of the deceased's lives.

The living descendants of the departed desire and cannot obtain further information in many cases. The engraved information represents the extent of what is known about the deceased and what information propagates through time. The living visit the deceased with the inability to learn and then pass on memories of the deceased at the gravesite. It becomes difficult for the living to understand what connection exits between the deceased and the living or appreciate the accomplishments of the deceased's while living.

Additionally, over time, the bodily remains of the deceased may become misidentified and lost. Markers are removed or destroyed over decades or centuries, and bodies disinterred and reinterred at alternate locations. Coffins deteriorate. Remains of the departed commonly become unidentified. There exists no efficient means in the art of associating the physical remains of the deceased with a name or a marker identifying said remains.

Accordingly, there remains a need in the art for a grave marker, or memorial, which provides more data than what can be engraved on a gravestone—as well as means for associating the physical remains of a person with said marker. Ideally, computer readable information about the deceased would be available and accessible at the situs of a gravestone itself, with interface means adapted to allow the free flow of information to visitors in a way which is resistant to the effects of rain, snow, ice, sun and weather over time.

With the foregoing in mind, it is therefore a primary object of the present invention to provide a memorial having persistent computer-readable memory and interface means. In view of the foregoing, it should be clear that there is a need in the industry for such a memorial which is taught by the present disclosure.

### SUMMARY

From the foregoing discussion, it should be apparent that a need exists for a memorial having persistent computer-readable memory and interface means. Beneficially, such an apparatus would provide long-lasting physical components and digital means efficacious for helping to cure the above-described deficiencies with memorials in the prior art.

The present invention has been developed in response to the present state of the art, and in particular, in response to the problems and needs in the art that have not yet been fully solved by currently available apparatus and methods. Accordingly, the present invention has been developed to provide a long-term memorial for descendants and other posterity. To provide this memorial, the present invention also provides the living with the ability to transfer the deceased's identity and medical information as well as documenting the individual's life history, achievements and familial relationships for posterity.

The stone memorial may comprise: a base stone adapted to rest on one of a ground surface and subgrade; a tablet stone affixed superiorly to the base stone; a table stone affixed superiorly to the tablet stone, the table stone cantilevering over a forward face of the tablet stone such that a lower surface of the table stone overhangs the forward face of the tablet; wherein the table stone comprises a computer-readable ROM memory unit accessible through a port disposed on the lower surface of the table stone, such that table stone protects the port from direct exposure to sunlight and precipitation; wherein data written into the computer-readable memory unit comprises a unique identifier exclusively associated in a database with a deceased person to whom the memorial pays tribute; wherein data written into the computer-readable memory unit further comprises one or more of: a name, a birth date, a death date, a marriage date, photographs, a life story, journal records, memoirs, and genealogical information; wherein the computer-readable memory unit is powered by a data processing device (DPD) under the control of a visitor interfacing with the computer-readable memory.

The table stone and tablet stone may be formed as a single integrated piece in some embodiments. The stone memorial may further comprise a passive RFID tag adapted to wireless signal the unique identifier to the DPD when exposed to a magnetic field.

The unique identifier may be engraved upon the forward face of the tablet stone.

A second stone memorial is provided comprising: a base stone adapted to rest on one of a ground surface and subgrade; a tablet stone affixed superiorly to the base stone; a table stone affixed superiorly to the tablet stone, the table stone cantilevering over a forward face of the tablet stone such that a lower surface of the table stone overhangs the forward face of the tablet; wherein the tablet stone comprises a computer-readable ROM memory unit accessible through a port disposed beneath the lower surface of the table stone, such that table stone protects the port from direct exposure to sunlight and precipitation; wherein data written into the computer-readable memory unit comprises a unique identifier exclusively associated in a database with a deceased person to whom the memorial pays tribute; wherein data written into the computer-readable memory unit further comprises one or more of: a name, a birth date, a death date, a marriage date, photographs, a life story, journal records, memoirs, and genealogical information; wherein the computer-readable memory unit is powered by a data processing device (DPD) under the control of a visitor interfacing with the computer-readable memory.

The table stone and tablet stone may be formed as a single integrated piece.

The stone memorial may further comprise a passive RFID tag adapted to wireless signal the unique identifier to the DPD when exposed to a magnetic field. The unique identifier may be engraved upon the forward face of the tablet stone.

A stone memorial system is also provided comprising: a base stone adapted to rest on one of a ground surface and subgrade; a tablet stone affixed superiorly to the base stone; a table stone affixed superiorly to the tablet stone, the table stone cantilevering over a forward face of the tablet stone such that a lower surface of the table stone overhangs the forward face of the tablet; wherein the table stone comprises a computer-readable ROM memory unit accessible through a port disposed on the lower surface of the table stone, such that table stone protects the port from direct exposure to sunlight and precipitation; wherein data written into the computer-readable memory unit comprises a unique identifier exclusively associated in a database with a deceased person to whom the memorial pays tribute; wherein data written into the computer-readable memory unit further comprises one or more of: a name, a birth date, a death date, a marriage date, photographs, a life story, journal records, memoirs, and genealogical information; wherein the computer-readable memory unit is powered by a data processing device (DPD) under the control of a visitor interfacing with the computer-readable memory; a first passive RFID tag affixed to skeletal remains interred beneath the ground surface, the first passive RFID tag adapted to transmit the unique identifier when exposed to a magnetic field, wherein the first passive RFID tag is encased in a nonbiodegradable polymeric materials before interment.

The first RFID tag may be affixed to the skeletal remains before interment. The stone memorial may further comprise a second passive RFID tag recessed into the memorial stone adapted to wireless signal the unique identifier to the DPD when exposed to a magnetic field.

The unique identifier in the system may be engraved upon the forward face of the tablet stone.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may combine in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric, side perspective view illustrating one embodiment of a marker having persistent computer-readable memory and interface means in accordance with the present invention;

FIG. 2 is a lower isometric, side perspective view illustrating one embodiment of a marker having persistent computer-readable memory and interface means in accordance with the present invention;

FIG. 3A is a sectioned, side perspective view illustrating one embodiment of a marker having persistent computer-readable memory and interface means in accordance with the present invention;

FIG. 3B is a sectioned, side perspective view illustrating another embodiment of a marker having persistent computer-readable memory and interface means in accordance with the present invention;

FIG. 3C illustrates a sectioned, side perspective view of an interface module of a marker having persistent computer-readable memory and interface means in accordance with the present invention;

FIG. 3D illustrates a sectioned, side perspective view of another embodiment of an interface module of a marker having persistent computer-readable memory and interface means in accordance with the present invention;

FIG. 3E illustrates a sectioned forward perspective view of a marker 380 having a detachable interface module 352 in accordance with the present invention;

FIG. 4 is an environmental side perspective view illustrating one embodiment of physical remains of a deceased individual exclusively associated with a marker and name in accordance with the present invention;

FIG. 5 is an exploded, environmental side perspective view illustrating physical remains of a deceased individual exclusively associated with a marker and name in accordance with the present invention; and

FIG. 6 is a block diagram illustrating a system for enabling interface between a grave marker and DPD in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method.

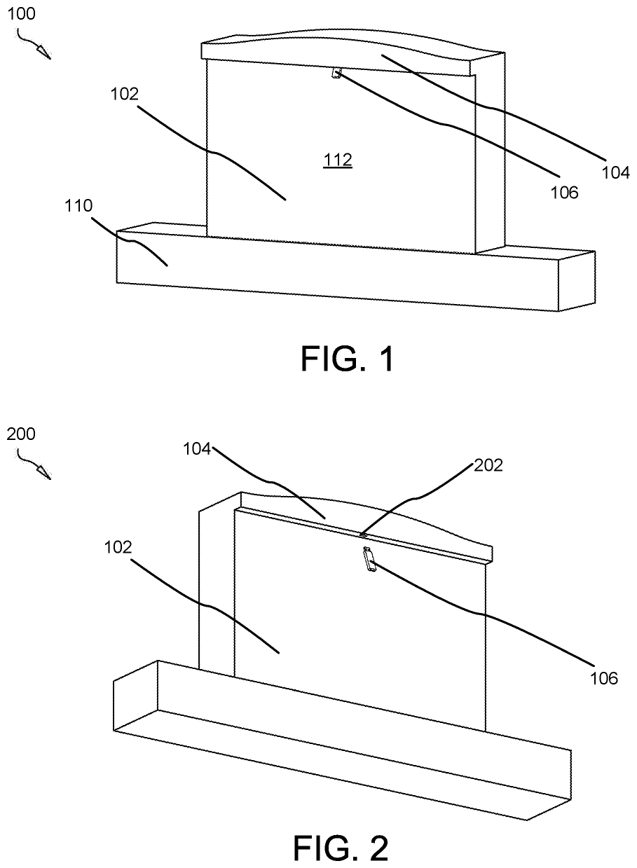

FIGS. 1-2 illustrate isometric, side perspective views of one embodiment of a marker having persistent computer-readable memory and interface means in accordance with the present invention.

The gravestone 102 comprises an upright stone slab, pedestal, tablet or slate having a plurality of substantially planar faces as shown. The gravestone 102 may be fabricated from materials known to those of skill in the art, such as granite, marble, sandstone, quartz, metal, zinc, cement and the like. The gravestone 102 comprises a forward face 112.

The marker 100 may comprise an upright headstone, kerbed headstone, ledger stones, chest tomb, table tomb, obelisk, pillar, mausoleum, and the like. In some embodiments, the marker 100 does not comprise a base stone 110 or a table stone 104.

The apparatus (or market or tombstone or memorial) 100 comprises a base stone 110 or foundation, as shown, upon which the tablet 102 sits. The base stone 110 and tablet 102 may be formed as a single integrated piece. A pillow stone, or table stone 104 (or raised ledger) positions above the tablet 102, which may also be formed as a single integrated piece with the tablet 102.

The table stone 104 cantilevers outwardly from the tablet 102 such that the table stone 104 overhangs the forward face 112 of the tablet stone 102. A digital port 202, in the shown embodiment, positions on a lower surface 354 of the table stone 104. This positioning prevents elements such as rain, snow and ice, from penetrating into and accumulating on the port 202, as precipitations runs downwardly toward a ground surface. The digital port 202 may comprise a USB port (universal serial bus) or any other port standardized to connect peripherals to personal computers, both to communicate logically and to power said devices. In various embodiments, power is supplied to the computer-readable memory from a visitor's data processing device (DPD). The port 202 is an interface designed to allow access between the marker 100 and a DPD in the possession of a visitor.

Reference to DPDs may include a tablet computer, smartphone, or laptop under the control of the visitor. The DPD may include server(s) operating independently of the visitor, configured to facilitate the receipt, maintenance and provision of information between the marker 100 and the visitor.

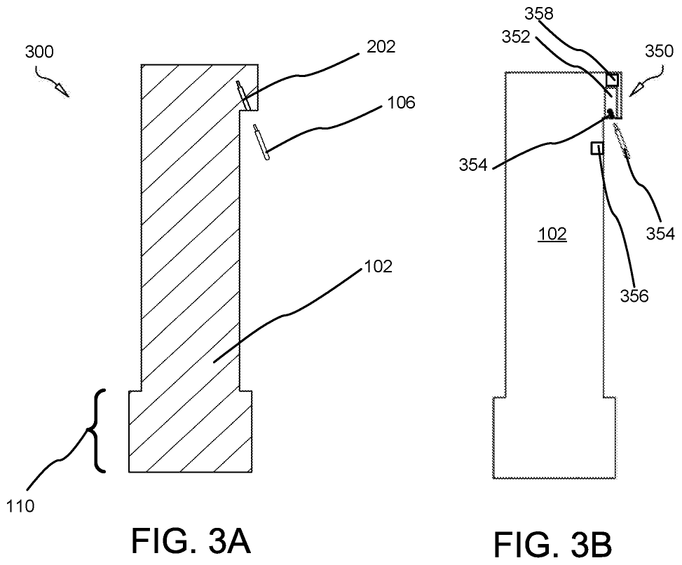

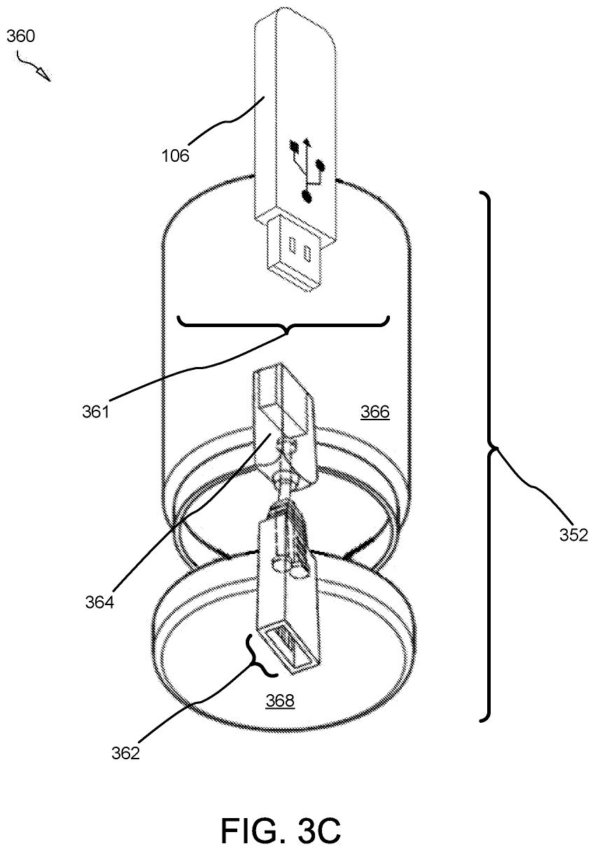

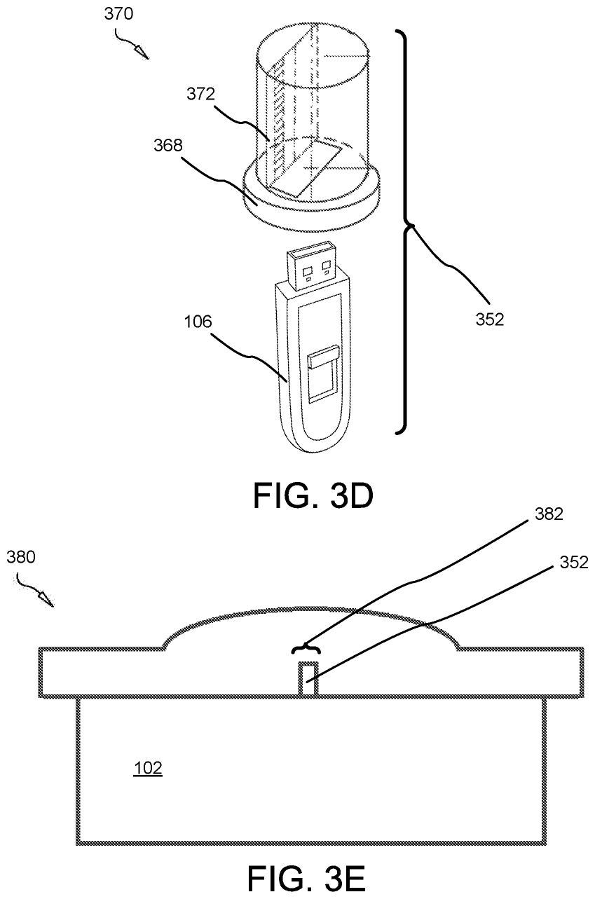

FIGS. 3A-3B illustrates a sectioned, side perspective view of one embodiment of a marker having persistent computer-readable memory and interface means in accordance with the present invention.

Recessed within the lower surface 354 is persistent, computer-readable memory 352, which may be read only (ROM) or passive such that power must be supplied by the DPD to the computer-readable memory 352 to access it. The computer-readable memory may comprise flash memory, such as a USB flash drive 106 permanently embedded in the headstone 100. The ROM or EPROM memory may comprise any non-volatile computer readable memory including firmware, CD ROMs, disk drives, and other computer-readable memory known to those of skill in the art. In some embodiments, the computer-readable memory 352 comprises a passive RFID tag 358 adapted to signal data transfer between the RFID tag 358 and a DPD. The RFID tag 358 may comprise an HF tag, a UHF tag, an SHF tag, or other RFID tags known to those of skill in the art. The RFID tag 358 may be adapted or configured to transmit an EPC code comprises a number exclusively associated with the deceased, which number may be used for reference purposes on other computer networks or to retrieve information from a DBMS or RDBMS. The marker may comprise a plurality of RFID tags 358.

The memory 352 may be detachable from the marker 300 or may be permanently affixed therein. The memory 352 may be adapted to be removable using means known to those of skill in the art, including locking into the marker 300 or sliding into the marker 300 on a track recessed into the marker 300. In various embodiments, the marker 100 comprises a plurality of memory units 352 for redundancy. In some embodiments of the present invention, the memory 354 may be organized or encrypted such that some or all of the data in memory is accessible only to visitors which an encryption key or password using means known to those of skill in the art.

As shown, the port 202 is angled, or inclined, away from an orthogonal orientation relative to the lower surface 354 such that water and ice do not accumulate within the port 202. Moisture will tend to run from the port 202, leaving the port unobstructed. In other embodiments, the port 202 is oriented orthogonally, or perpendicularly to, the lower surface 354. The memory 352 is elevated, in the present embodiment, above a ground surface 402 to prevent snow pack, rising flood waters, and accumulating debris such as leaves from reaching the elevation of the port 202, which might otherwise cover the port 202 if the port 202 were disposed on the base stone 110 or on the tablet 102.

Hence, in general terms, the present invention provides for a raised digital interface recessed into a marker 100 which provides read-only access to computer-readable persistent memory to a visitor, the persistent memory comprising data about the deceased, including by way of example: photographs, life stories, name, genealogy, birth and death dates, journal entries, memoirs, religious documents, and the like. In various embodiments, this data may be downloaded from the marker 300 by a visitor.

In some embodiments, data in the computer-readable memory 352 is transmitted wirelessly to the DPD using means know to those of skill in the art to one or more separate DPDs, for instance using Bluetooth® technology or other wireless technology for relaying and receiving electrical signals enabling device-to-device communication. By way of example, this functionality may be provided by incorporating the Bluetooth Intercom Profile® and/or the Bluetooth Telephony Profile®, the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

The marker 300 may additionally or alternatively comprise a second port 356 functionally the same as the port 202. The port 202 may be disposed on the tablet stone 102 beneath the table stone 104.

FIG. 3C illustrates a sectioned, side perspective view of an interface module 360 of a marker having persistent computer-readable memory and interface means in accordance with the present invention.

The interface module 360 includes a housing 352 comprising a hollow interior recess 361 adapted to receive and house the components necessary to impart memory and interface function to the marker 100. These components include passive, persistent computer-readable memory 106, which memory 106 may comprise flash memory, a solid state drive (SSD), or other memory as known to those of skill in the art as further described above.

In the shown embodiment, the memory 106 comprises a USB flash drive having integrated flash memory and an integrated USB interface. The USB flash drive, in the shown embodiment, is coupled to, or mated with, a double-female adapter 364 configured to enable logical connectivity between the memory 106 and a DPD vis-à-vis a USB cable inserted into port 362 as shown. In some embodiments, the memory 106 is detachably removable from the interface module 360. In other embodiments, the memory 106 is formed with the interface module 360 such that the entire interface module 360 must periodically be replaced and its data transferred to another computer-readable medium or o the replacement interface module 360.

The interface module 360 (or memory unit) may also comprise a protocol converter adapted to convert standard proprietary protocol of one device to a protocol suitable for a DPD plugged into the interface module 360.

While the shown embodiment depicts a USB port 362 (or receptacle 362), any interface means may be used in the present invention which facilitates end-to-end connectivity between the memory 106 and a host and/or peripherals, including means making use of Ethernet cables, USB cables, other cables known to those of skill in the art and the like.

The housing 352 may be cylindrical as shown, or alternatively may be cubic or any other shape. The housing 352 inserts into a hollow recess disposed inferiorly to the cantilever of the marker 100 within said marker 100.

The housing 352 comprises a flange 362 which may be a cap which is affixed to the main body 366 of the housing 352. In various embodiments, the flange 362 cantilevers outwardly in annular fashion from the main body 366. The recess 382 in the marker 380 (further described below) which receives the housing 352 may be shaped in tiered, or birthday-caked fashion, to receive both the main body 366 and the flange 368 of the housing 352.

FIG. 3D illustrates a sectioned, side perspective view of another embodiment of an interface module 370 of a marker having persistent computer-readable memory and interface means in accordance with the present invention.

In the preferred embodiment, the memory 106 is passive, meaning outside power must be supplied by a DPD or other source to access the memory rather than being supplied by the marker 100; however, in some embodiments, the interface module 370 comprises its own processor 372 and power supply as shown.

FIG. 3E illustrates a sectioned forward perspective view of a marker 380 having a detachable interface module 352 in accordance with the present invention.

In various embodiments, the marker 380 defines a hollow interior recess 382. The hollow interior recess 382 may be cylindrical and dimensioned to receive the interface module 360, which may detachably affix into the marker 380. In some embodiments, the interface module 360 is adhered into the recess 382 using adhesive. In other embodiments, the recess 382 is threaded to mate with exterior threading on the interface module 360 such that the interface module 360 in screwed into the marker 380. In still further embodiments, the interface module 360 is held in place using a friction fit.

In some embodiments, the interface module 360 in not positioned directly below the cantilever 104. In some embodiments of the present invention, the interface module 360 is positioned elsewhere on the marker, using cables to interconnect a port 362 and the interface module 360.

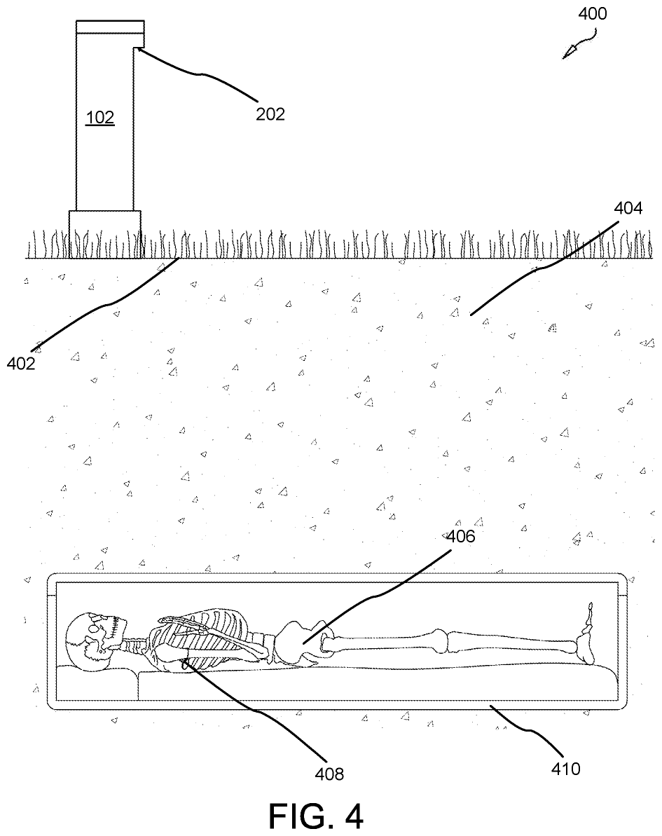

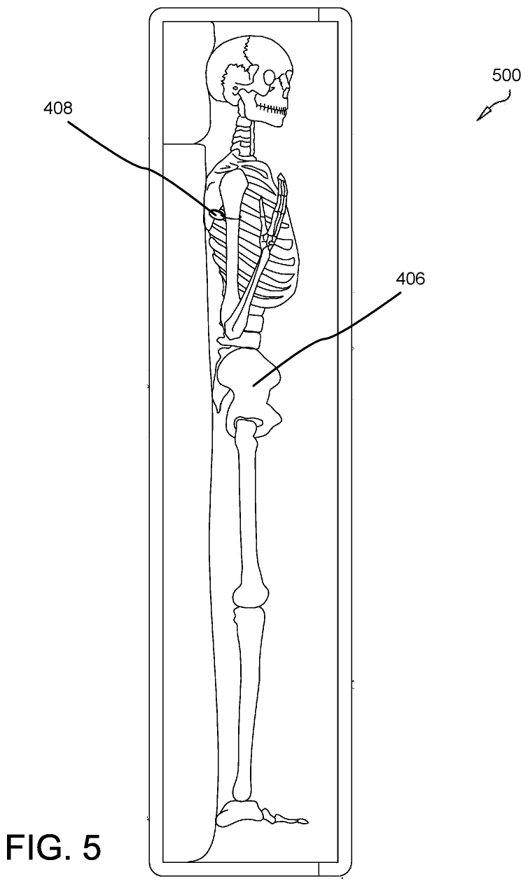

FIGS. 4-5 illustrate environmental side perspective views of physical remains of a deceased individual exclusively associated with a marker and name in accordance with the present invention.

The system 400 may include a passive, skeletal RFID tag 408 adapted to signal between the RFID tag and a DPD when the tag 408 is exposed to an electromagnetic field. The RFID tag may comprise an HF tag, a UHF tag, an SHF tag, or other RFID tags known to those of skill in the art. The RFID tag 408 may be adapted and configured to transmit an EPC code. In some embodiments, the remains 406 of the departed may be interred too deeply within the ground 404 beneath a ground or subgrade to facilitate automatic identification and data capture using passive RFID technology, in which case the RFID continues to serve the utilitarian purpose of facilitating identification of the remains 406 if the remains are disinterred.

The RFID tag 408 is surgically affixed as shown to the humerus of the deceased before interment to ensure the RFID remains attached to skeletal remains of the deceased after decomposition. In other embodiments, the RFID tag 408 is simply placed within a coffin 410 alongside the deceased or affixed to the body of the deceased or the deceased's clothing using nonsurgical means, such as affixing the RFID tag 408 to a belt or around an arm or appendage of the deceased. The RFID tag 408 transmits, or signals, in some embodiments, a 96 bit stream of data which may comprise a numeral (or unique identifier) exclusively associated with the deceased or a string of characters representing the deceased's name and/or birth or death date. For instance, the numeral in base 10 indicated by the unique identifier may 0978653421 which may be exclusively associated with a deceased name John A. Smith born on Dec. 31, 1910 by way of example in a database under the control of a cemetery or genealogical association. In other embodiments, the unique identifier may be the character string, “johnasmith” or “John a. Smith” or “johnasmith12311910” or any other variation which could be exclusively identified with the deceased.

The RFID tag 408 may be encased in waterproof or nonbiodegradable polymeric materials designed to last indefinitely.

FIG. 5 is an environmental side perspective view illustrating an exploded view of physical remains of a deceased individual exclusively associated with a marker and name in accordance with the present invention.

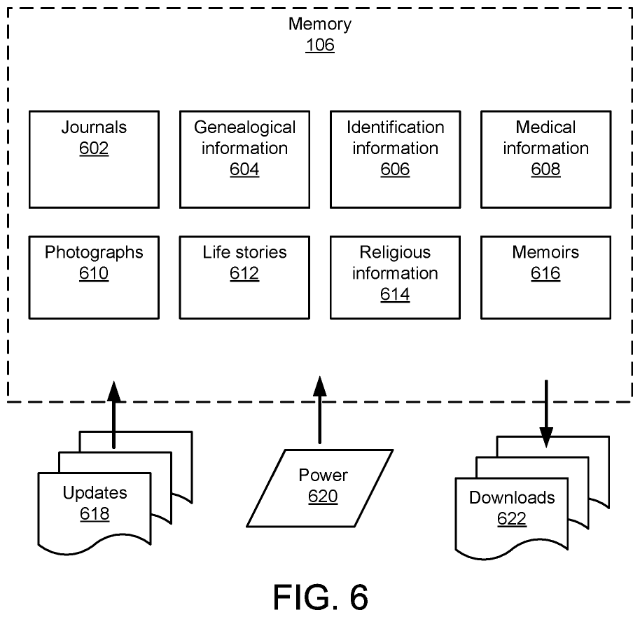

FIG. 6 is a block diagram illustrating a system for enabling interface between a grave marker and DPD in accordance with the present invention.

The memory 106 may comprise data on a computer-readable medium organized into computer files and/or an RDBMS system. In various embodiments, this data is organized as journals 602 of the deceased; genealogical information 604 of the deceased; identification information 606 including names, birth dates, death dates; medical information 608 of the deceased, photograph 610 of the deceased, life stories of the deceased 612, religious information including baptismal information and marriage; and memoirs 616 of the deceased.

In various embodiments, the updates 618 may be supplied, or uploaded, to the memory 106 from a DPD in logical connectivity therewith. Uploads 618 may comprise updates to genealogical information supplied by descendants. Power 620 may likewise be supplied. The files 602-616 may be downloaded in a single data transfer 622.

The files 602-616 may be backed up in central computer memory under the control of a memorial stone authority, or organization charged with maintaining grave markers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A stone memorial comprising:
a base stone adapted to rest on one of a ground surface and subgrade;
a tablet stone affixed superiorly to the base stone;
a table stone affixed superiorly to the tablet stone, the table stone cantilevering over a forward face of the tablet stone such that a lower surface of the table stone overhangs the forward face of the tablet;
wherein the table stone comprises an interface module having computer-readable memory unit accessible through a port disposed on the lower surface of the table stone, such that table stone protects the port from direct exposure to sunlight and precipitation;
wherein data written into the computer-readable memory unit comprises a unique identifier exclusively associated in a database with a deceased person to whom the memorial pays tribute;
wherein data written into the computer-readable memory unit further comprises one or more of: a name, a birth date, a death date, a marriage date, photographs, a life story, journal records, memoirs, and genealogical information;
wherein the computer-readable memory unit is powered by a data processing device (DPD) under the control of a visitor interfacing with the computer-readable memory.

2. The stone memorial of claim 1, wherein the table stone and tablet stone are formed as a single integrated piece.

3. The stone memorial of claim 1, further comprising a passive RFID tag adapted to wireless signal the unique identifier to the DPD when exposed to a magnetic field.

4. The stone memorial of claim 1, wherein the unique identifier is engraved upon the forward face of the tablet stone.

5. The stone memorial of claim 1, wherein the memory unit comprises a polymeric housing affixed into a recess in the stone memorial.

6. A stone memorial comprising:
a base stone adapted to rest on one of a ground surface and subgrade;
a tablet stone affixed superiorly to the base stone;
a table stone affixed superiorly to the tablet stone, the table stone cantilevering over a forward face of the tablet stone such that a lower surface of the table stone overhangs the forward face of the tablet;
wherein the tablet stone comprises a computer-readable ROM memory unit accessible through a port disposed beneath the lower surface of the table stone, such that table stone protects the port from direct exposure to sunlight and precipitation;
wherein data written into the computer-readable memory unit comprises a unique identifier exclusively associated in a database with a deceased person to whom the memorial pays tribute;
wherein data written into the computer-readable memory unit further comprises one or more of: a name, a birth date, a death date, a marriage date, photographs, a life story, journal records, memoirs, and genealogical information;
wherein the computer-readable memory unit is powered by a data processing device (DPD) under the control of a visitor interfacing with the computer-readable memory.

7. The stone memorial of claim 6, wherein the table stone and tablet stone are formed as a single integrated piece.

8. The stone memorial of claim 6, further comprising a passive RFID tag adapted to wireless signal the unique identifier to the DPD when exposed to a magnetic field.

9. The stone memorial of claim 6, wherein the unique identifier is engraved upon the forward face of the tablet stone.

10. A stone memorial system comprising:
a base stone adapted to rest on one of a ground surface and subgrade;
a tablet stone affixed superiorly to the base stone;
a table stone affixed superiorly to the tablet stone, the table stone cantilevering over a forward face of the tablet stone such that a lower surface of the table stone overhangs the forward face of the tablet;
wherein the table stone comprises a cylindrical housing defining a hollow interior recess and overhanging flange, the hollow interior recess housing a computer-readable ROM memory unit accessible through a port disposed on the lower surface of the table stone, such that table stone protects the port from direct exposure to sunlight and precipitation;
wherein the interface module is detachably affixed into a hollow interior recess defined by one of the tablet stone and the table stone;
wherein data written into the computer-readable memory unit comprises a unique identifier exclusively associated in a database with a deceased person to whom the memorial pays tribute;
wherein data written into the computer-readable memory unit further comprises one or more of: a name, a birth date, a death date, a marriage date, photographs, a life story, journal records, memoirs, and genealogical information;
wherein the computer-readable memory unit is powered by a data processing device (DPD) under the control of a visitor interfacing with the computer-readable memory;
a first passive RFID tag affixed to skeletal remains interred beneath the ground surface, the first passive RFID tag adapted to transmit the unique identifier when exposed to a magnetic field, wherein the first passive RFID tag is encased in a nonbiodegradable polymeric materials before interment.

11. The stone memorial of claim 10, wherein the first RFID tag is affixed to the skeletal remains before interment.

12. The stone memorial of claim 10, further comprising a second passive RFID tag recessed into the memorial stone adapted to wireless signal the unique identifier to the DPD when exposed to a magnetic field.

13. The stone memorial of claim 10, wherein the unique identifier is engraved upon the forward face of the tablet stone.
